(19) United States
(12) Patent Application Publication
(10) Pub. No.: US 2019/0293916 A1
(43) Pub. Date: Sep. 26, 2019

(54) OBJECTIVE LENS ATTACHMENT

(71) Applicant: LIG Nanowise Limited, Birmingham (GB)

(72) Inventors: Sorin Stanescu, Birmingham (GB); Wei Guo, Birmingham (GB); Lin Li, Birmingham (GB)

(21) Appl. No.: 16/317,659

(22) PCT Filed: Jul. 13, 2017
(86) PCT No.: PCT/GB2017/052060

§ 371 Date: Jan. 14, 2019

(30) Foreign Application Priority Data
Jul. 14, 2016 (GB) 1612254.1

(51) Int. Cl. G02B 21/02; G02B 21/00; G02B 3/00

(52) U.S. Cl. CPC G02B 21/02; G02B 3/0087; G02B 21/002

(57) ABSTRACT

An objective lens attachment (10) positions a microsphere lens (13) between the objective lens (2) and a sample. The attachment (10) is adapted to position the microsphere lens at a desired separation from the objective lens (2) to provide optimal super resolution imaging performance. The objective lens attachment (10) comprises a cap (14) having a substantially tubular body (15) and a top (16). The top (16) is provided with a contact surface (17) surrounding an aperture (18). The aperture (18) is aligned with the objective lens when the cap (14) is fitted to the objective lens housing (3). A support sheet (11) formed from optically clear material is affixed to the cap (14). Upon the support sheet (11) is provided an adhesive layer (12). Affixed to the adhesive layer (12) is a microsphere lens (13), the microsphere lens being aligned with the centre of the objective lens (2).

### TECHNICAL FIELD OF THE INVENTION

The present invention relates to an objective lens attachment. In particular, the invention relates to an objective lens attachment comprising a single microsphere lens. The objective lens attachment may be suitable for super resolution microscopy, imaging or fabrication. The present invention further relates to the manufacture and use of such objective lens attachments.

### BACKGROUND TO THE INVENTION

Conventional optical microscopic imaging resolution has a theoretical limit of approximately 200 nm within the visible light spectrum due to the far-field diffraction limit. As a result, conventional optical microscopic imaging is not suitable for imaging subjects having structures smaller than this limit, for example live viruses (typically 5-150 nm, with some up to 300 nm). In order to image such structures beyond the optical diffraction limit, other techniques have been used.

Transmission electron microscopy (TEM) and scanning electron microscopy (SEM) are often used to image specially prepared dead virus structures at very high resolutions (10 nm) in vacuum. These techniques require complex sample preparation and are not suitable for in vivo imaging and measurements (the electron beam affects the living cells, viruses etc.).

Atomic force microscopes (AFMs) offer good imaging of small features samples by a contacting probe. The sample may be easily damaged by the AFM's tip. Moreover, this technique does not offer a real image but a reconstructed imaging.

Stimulated emission depletion (STED) fluorescence optical microscopy is a recently established method for the imaging of cellular structures, bacteria and viruses beyond the optical diffraction limit, down to a resolution of 6 nm. This technique is based on the detection of light emitted by the fluorescing specimen when it is excited by laser light of a specific wavelength and switching off part of the fluorescent zone using another laser light of a different wavelength. STED fluorescent microscopes offer a better resolution but the sample also requires a complex preparation (fluorescent labelling), which may not be always suitable for living organisms imaging. The fluorescent imaging technique gives good results mainly for organic samples. However, for high resolution, this technique is confronted with the challenge of photo bleaching which limits the minimum exposure time of light exposure to tens of seconds.

Recently, super resolution imaging has been demonstrated using arrays of microspheres positioned between objective lens and sample. The microspheres used in such arrays are typically of the order of 10 μm in diameter. Use of microspheres enables the capture of evanescent waves present at the boundary of two different media with different refractive indices in the “far field” zone. These evanescent waves carry high spatial frequency sub-wavelength information and decay exponentially with distance. Hence microspheres close to a surface are more effective at detection of said evanescent waves than a conventional objective lens.

CN102305776B discloses a microsphere of 1-9 um diameter used as a lens, in contact with a target or having less than 100 nm separation from the target for imaging. The imaged target must be metallic or gold coated (for semiconductor material). The measurement mechanism is based on detecting surface plasmons which occur between metal and non-metal. The microsphere holders have two types: a tapered hole ˜8 μm on top and 2.8 μm at bottom in silicon to set the sphere using UV curable adhesive; and a transparent glass tip fixing the microsphere using UV curable adhesive. Such arrangements are not especially robust or adapted for ready fitting to existing microscopes. Furthermore, the microsphere is not attached to the objective lens and thus alignment to the optical axis of the objective lens is not guaranteed

WO2015/025174A1 discloses an array of microspheres embedded in a host material (elastomer or glass or plastic) and placed on the workpiece. Such a sheet of lenses may be reusable, for imaging. Microsphere arrays can be difficult to manufacture and are rather delicate and easily damaged. The use of such small microspheres also presents difficulties in increased distortion of the image and a more restricted field of view. Furthermore, the microspheres are not attached to the objective lens and thus alignment to the optical axis of the objective lens is not guaranteed.

Super resolution imaging apparatus can also be adapted to use in laser based micro fabrication. In such techniques, fabrication resolution is limited by the size of focused laser beam spot. This is of the order of half the laser wavelength, thus machining sub-wavelength features are difficult. Previous efforts have demonstrated the use of microspheres spread on the target surface to allow super-resolution imaging or sub-wavelength laser machining. For practical machining techniques the microspheres must not be placed on the machining target. Such techniques would thus also require a mounting arrangement that is simple, robust, allows for accurate positioning and is readily fitted to existing microscopes. It is therefore an object of the present invention to enable super resolution microscopy and/or micro-machining that at least partially overcomes or alleviates some of the above problems.

### SUMMARY OF THE INVENTION

According to a first aspect of the present invention there is provided an objective lens attachment for a microscope, the attachment comprising: a cap locatable in relation to the outer housing of the objective lens; a support sheet affixed to the cap; an adhesive layer provided on the support sheet; and a microsphere lens affixed to the support sheet by the adhesive layer, the microsphere lens aligned to the optical axis of the objective lens.

The objective lens attachment above thus allows the microscope to be used for super resolution microscopy and laser micro-machining. The support sheet and adhesive layer allows the microsphere to be accurately positioned at a fixed distance from the objective lens and aligned to the optical axis in use for optimal performance. The fixing of the microsphere in position using the adhesive layer provides for a simple and robust construction of the attachment. Such a system is suitable for both metallic and non-metallic target materials and in particular, suitable for imaging and processing biological samples (e.g. cells).

The microsphere lens may comprise a microsphere or a truncated microsphere. The use of a microsphere rather than a truncated microsphere increases resolution but also increases distortion. For the avoidance of doubt, a truncated microsphere comprises a microsphere truncated by a plane perpendicular to the optical axis.

The microsphere lens may have a diameter of in the range 30-1000 μm. In one embodiment, the microsphere lens may have a diameter in the range 90-106 μm. In particular, the microsphere lens may have a diameter of around 100 μm.

The microsphere may have a refractive index in the range of 1.5-4. In one embodiment, the microsphere lens may have a refractive index in the range 1.55-2.4. In particular, the microsphere lens may have a refractive index of around 1.9-2.2. The microsphere lens may be formed from any suitable material, including but not limited to Barium Titanate (BaTiO₃), polystyrene, silica (SiO₂), diamond, sapphire (Al₂O₃), titanium dioxide, cubic zirconia, zinc oxide, silicon, germanium, gallium phosphide, and gallium arsenide or the like.

The cap may comprise a substantially tubular body and a top. The substantially tubular body may have a cross-section corresponding to the outer housing of the objective lens. The cap may be releasably attachable to the housing of the objective lens. Releasable attachment may be facilitated by provision of an attachment formation on the inner surface of the body. In one embodiment, the attachment formations may comprise a screw thread for engaging with a corresponding thread provided upon to outer surface of the objective lens housing.

The relative displacement of the cap from the objective lens along the optical axis may be adjustable. In such embodiments, the cap may be connected via adjustment means to a base. The base may be adapted to attach to the housing of the objective lens in a fixed location. The base may comprise a collar provided with reliable attachment means. The adjustment means may be operable to enable adjustment of the relative displacement of the cap and the mounting collar. Adjusting the relative displacement of the cap and the mounting collar allows the relative displacement of the cap from the objective lens along the optical axis to be adjusted. In some embodiments, the adjustment means may comprise piezoelectric actuators. In other embodiments, the adjustment means may comprise of elongate threaded elements. In such embodiments, the adjustment means may further comprise a stepper motor operable to drive adjustment along the elongate threaded elements.

In some embodiments, the cap may be fitted to a scanning stage. In such embodiments, the cap may be fitted within a dedicated socket provided in the scanning stage. The scanning stage can be operated to control the location of the cap relative to the objective lens. In particular the scanning stage may offer ready adjustment of the relative displacement of the cap from the objective lens along the optical axis and/or the relative displacement of the cap from the objective lens in a plane perpendicular to the optical axis.

In embodiments wherein the relative displacement of the cap from the objective lens along the optical axis is adjustable, a graded index optical element may be provided between the support sheet and the objective lens. Alternatively, in such embodiments, the support sheet may comprise the end face of a graded index optical element. The graded index optical element may be any suitable element wherein the element has a refractive index that decreases with increasing radial distance from the optical axis of the element. In particular, the element may be an optical fibre, lens, glass rod, polymer rod, semiconductor rod or the like. The graded index optical element can provide compensation for the variation in separation between the cap and the microsphere lens as the all optical paths (refractive index multiplied by distance) are the same due to the radially varying refractive index.

Where the objective lens is intended for immersion in fluid during use, the cap may be provided with a seal so as to retain said fluid between the support sheet and the objective lens. In some embodiments the fluid may be water. In other embodiments, the fluid may be an oil. In such embodiments, the cap may be provided with valve allowing for the introduction of fluid between the cap and objective lens and/or the removal of fluid between the cap and objective lens.

The top of the cap may be provided with an aperture. The cap aperture may be the same size as or larger than the objective lens. The cap aperture may be provided within a surrounding contact surface. The support sheet may be affixed to the contact surface. In some embodiments, the contact surface may be provided within a recess around the cap aperture. The support sheet may be fitted to the cap by any suitable means. In particular, the support sheet may be affixed to the cap by adhesive. In one embodiment, the support sheet may be affixed to the cap by a UV curable adhesive such as NOA 81, MY-132, MY132A or the like. Such adhesives are commonly used for connecting optical fibres. It is evident that the adhesive should have good optical transparency. In a preferred embodiment, the adhesive may have a lower refractive index than the microsphere lens material.

The cap and recess may be such that the support sheet either abuts or is substantially adjacent to at least part of the surface of the objective lens. This allows the separation between the microsphere lens and the objective lens to be maintained at a desired distance and separation between the objective lens and the sample to be maintained at a desired distance. The desired separation between the objective lens and the microsphere lens and the desired separation between the objective lens and the sample will depend upon the power of the objective lens, numerical aperture of the objective lens, the properties of the microsphere lens and the surrounding media. The separation distance between the objective lens and the microsphere is critical for imaging. The separation distance may be selected such that the focal position is at the virtual imaging plane of the combined optical system. This is normally well below (typical around one diameter of the microsphere) the target surface.

The imaging plane position and additional image magnification factor introduced by the microsphere can be determined by considering the spherical lens effect and spherical aberration as:

$$\begin{matrix}f = \frac{d}{sin ( 2 {sin}^{- 1} ( \frac{d}{R} ) - 2 {sin}^{- 1} ( \frac{{n}_{0}}{{n}_{1}} \frac{d}{R} ) )} & ( 1 ) \\ s = \frac{( R + δ ) f}{f - R - δ} & ( 2 ) \\ M = \frac{f}{f - R - δ} & ( 3 )\end{matrix}$$

Where f is the focal length of the microsphere from the sphere centre, d is the transverse distance from the optical axis, R is the microsphere radius, n₀ is the ambient refractive index, n₁ is the refractive index of the microsphere, s is the virtual imaging plane position from the centre of the microsphere, M is the microsphere image magnification factor, and δ is the distance from the target to the microsphere surface.

The distance between the objective lens and microsphere lens is therefore:

D=S−f−R (4)

Where D is the distance between the objective lens and the microsphere lens, and S is the standard optimum working distance of the objective lens at which the target is on the focal plane of the objective lens without the microsphere. This distance may change when the refractive index of the media between the lens and the target surface varies.

A further and a critical embodiment of the this invention is the combination of a micro-adjustment mechanism in the objective lens in combination of the microsphere attachment, such that the distance between the objective lens and microsphere lens can be adjusted.

The cap may be formed from any suitable material. In some embodiments, the cap may be formed from a metal. In other embodiments, the cap may be formed from a plastic material or resin.

The support sheet may be formed from any suitable transparent material. In one embodiment, the support sheet is formed from glass. In alternative embodiments, the support sheet may comprise an alternative transparent material such as Poly (methyl methacrylate) (PMMA), Polydimethylsiloxane (PMDS) or the like. The support sheet provides a stable mount for the microsphere lens. The support sheet also provides additional structural rigidity to the cap.

The support sheet may have a thickness in the range of 50-200 μm. In one embodiment, the support sheet may have a thickness in the range 80-100 μm. In particular, the support sheet may have a thickness of around 100 μm.

The adhesive layer may comprise an optical adhesive applied to the spacing layer and spun to a desired thickness. In such embodiments, the adhesive layer may comprise a UV curable adhesive such as NOA 81, MY-132, MY132A or the like. The substance forming the adhesive layer may be selected so as to match optical properties of the support sheet and/or the microsphere. Alternatively, the adhesive layer may comprise an optically clear double sided adhesive tape of a known thickness applied to the spacing layer. Use of an adhesive tape of known thickness simplifies construction of the attachment. Suitable adhesive tapes include but are not limited to OCA8146-2, OCA8146-3 or the like.

The adhesive layer may have a thickness in the range 30-150 μm. In one embodiment, the adhesive layer may have a thickness in the range 50-75 μm. In particular, the adhesive layer may have a thickness of around 75 μm.

The attachment may comprise a surface coating layer. The surface coating may be applied over the adhesive layer and the microsphere lens. The surface coating layer provides additional structural stability for the attachment. The surface coating layer may also enhance captured images. In one embodiment, the surface coating layer is an adhesive. In such embodiments, the surface coating layer may comprise a UV curable adhesive such as NOA 81, MY-132, MY132A or the like. In another embodiment, the surface coating layer may be metallic. Suitable metals include, but are not limited to gold or silver. A combination of the two may be used.

The surface coating layer may be significantly thinner than the adhesive layer. In one embodiment, the surface coating layer may have a thickness in the range 1 nm-20 μm. In particular, the surface coating layer may have a thickness of around 5-10 nm μm in case of a metallic coating. In another embodiment, the surface coating layer thickness is around 5-20 μm in case of the use of UV curable adhesive.

The cap may be provided with sealing projections for retaining a fluid between the microsphere lens and the sample. The sealing projections may be formed of a resiliently deformable material. The fluid may be water or an oil.

According to a second aspect of the present invention there is provided a method of constructing an attachment for an objective lens attachment for a microscope, comprising the steps of: affixing a support sheet to a cap attachable to the outer housing of the objective lens; providing an adhesive layer on the support sheet; and affixing a microsphere lens to the adhesive layer.

The method of the second aspect of the present invention may incorporate any or all features of the first aspect of the present invention as desired or as appropriate.

The above method provides for the simple construction of an effective objective lens attachment for super resolution microscopy.

Providing the cap may include the steps of casting or otherwise machining metal where the cap is formed from metal. Providing the cap may involve the steps of moulding or otherwise machining plastic where the cap is formed from plastic.

Providing the cap may include the steps of 3-D printing the cap using a suitable printing resin.

Affixing the support sheet to the cap may be achieved by applying adhesive to contact surface of the cap and pressing the support sheet to the adhesive. If the adhesive is a curable adhesive, affixing may include curing the adhesive. If the adhesive is a UV curable adhesive, affixing may include irradiation with UV light to cure the adhesive.

Applying the adhesive layer to the support sheet may involve applying a desired quantity of an adhesive solution to the support sheet and spinning the support sheet until a uniform layer of a desired thickness is formed. If the adhesive is a curable adhesive, affixing may include curing the adhesive. If the adhesive is a UV curable adhesive, affixing may include irradiation with UV light to cure the adhesive.

Applying the adhesive layer to the support sheet may involve applying a layer of adhesive tape of a desired thickness to the support sheet. Use of an adhesive tape of known thickness simplifies construction of the attachment.

In one embodiment, the microsphere lens is affixed after the support sheet is affixed to the cap and the adhesive layer is applied to the support sheet. Affixing the microsphere lens to the support sheet may include placing the microsphere on a clean microscope slide; and approaching the microsphere lens with the adhesive layer of the support sheet. Affixing the microsphere lens may include centring the microscope slide relative to an objective lens of a microscope. Typically, centring may be carried out using a low magnification objective lens. Approaching the microsphere lens with the adhesive layer may be achieved by attaching the cap to the housing of a microscope objective lens and using the adjustment means of the microscope to approach the microsphere lens.

The method may comprise applying a surface coating layer over the adhesive layer and the microsphere lens. The surface coating layer may be applied by applying a desired quantity of an adhesive solution to the support sheet and microsphere lens and spinning the support sheet until a uniform layer of a desired thickness is formed. If the adhesive is a curable adhesive, affixing may include curing the adhesive. If the adhesive is a UV curable adhesive, affixing may include irradiation with UV light to cure the adhesive.

Where the cap comprises a graded index optical element, the method may include the additional step of affixing the graded index optical element to the support sheet and/or the cap. This may be achieved by use of adhesive. In particular, it may be achieved by use of optical adhesive.

According to a third aspect of the present invention there is provided a super resolution microscopy apparatus comprising: a microscope; a cap attached to the outer housing of the objective lens or the microscope; a support sheet affixed to the cap; an adhesive layer provided on the spacing sheet; and a microsphere lens affixed to the support sheet by the adhesive layer, the microsphere lens aligned to the optical axis of the objective lens.

The apparatus of the third aspect of the present invention may include any or all features of the first two aspects of the present invention as desired or as appropriate.

The apparatus may comprise illumination means operable to generate light to illuminate the sample. The generated light may be monochrome or broad spectrum as required or desired. The illumination means may be operable to illuminate the sample in reflection or transmission modes. In embodiments where the illumination means are operable to illuminate the sample in reflection, the apparatus may be provided with a restricted aperture between the illumination means and the objective lens. The restricted aperture may be operable to provide a narrow beam of illumination, thereby improving resolution.

The illumination means may be operable to generate polarised light. Alternatively, the apparatus may be provided with a polarising filter. Polarisation enables increased resolution to be achieved when imaging samples with multiple features aligned in a specific direction when the polarisation direction is substantially perpendicular to the feature alignment.

The apparatus may be provided with an imaging device operable to capture an image of the sample as viewed through the objective lens. Typically, the imaging device may comprise an optical sensing array such as a CCD (charge coupled device) array.

The imaging means may be connected to image processing means operable to process the captured image. The processing may include processing to remove radial (pincushion) distortions towards the edge of the microsphere lens. Additionally or alternatively, the processing may include other steps such as filtering, shadow removal, edge detection, inversion, or the like.

The apparatus may comprise a sample mount upon which sample may be positioned such that it can be viewed through the objective lens. The sample mount may be operable to controllably vary the separation between the objective lens and the sample. The sample mount may be operable to controllably vary the position of the sample relative to the objective lens in a plane perpendicular to the optical axis of the objective lens. In such cases, the sample mount may comprise a scanning stage. This can enable scanning of the sample relative to the objective lens so that an increased area of the sample can be imaged.

The apparatus may comprise multiple objective lenses. In such cases, the sample may comprise means for switching between said objective lenses.

The apparatus may be provided with a machining laser beam source. The machining laser beam may be aligned to pass through the objective lens and the microsphere lens. This can enable the use of the apparatus for micromachining of a target surface. In particular, this may enable subwavelength laser machining of a target surface.

According to a fourth aspect of the present invention there is provided a method of super resolution microscopy utilising a microscope according to the third aspect of the invention or a microscope provided with an attachment according to the first aspect of the present invention, the method comprising: providing a sample; positioning the objective lens and objective lens attachment relative to the sample and capturing one or more images of the sample.

The method of the fourth aspect of the invention may include any or all features of the previous aspects of the invention as desired or as appropriate.

The method may include illuminating the sample. The illumination may be monochrome or broad spectrum as required or desired. The illumination may be polarised. The illumination may illuminate the sample in reflection or transmission modes.

The method may include varying the separation between the objective lens and the sample. The method may include varying the position of the sample relative to the objective lens in a plane perpendicular to the optical axis of the objective lens. In particular, the method may involve scanning the sample relative to the objective lens. This enables an increased area of the sample to be imaged.

The method may include introducing a fluid between the objective lens attachment and the sample. The fluid may be introduced by application to the sample.

Additionally or alternatively, the method may include introducing a fluid between the objective lens and the objective lens attachment.

The method may include processing of the captured image. In particular, the method may include processing to remove radial distortions. Additionally or alternatively, the method may include other steps such as filtering, shadow removal, edge detection, inversion, image stitching or the like.

The method may include the additional step of machining the sample. Machining may be achieved by providing a machining laser beam source, aligned such that the machining laser beam passes through the objective lens and the microsphere lens; and machining a target surface of the sample by exposing it to the machining laser beam. Machining may take place at the same time as imaging.

According to a fifth aspect of the present invention there is provided a method of machining utilising a microscope according to the third aspect of the invention or a microscope provided with an attachment according to the first aspect of the present invention, the method comprising: providing a sample; positioning the objective lens and objective lens attachment relative to the sample; providing a machining laser beam source, aligned such that the machining laser beam passes through the objective lens and the microsphere lens; and machining a target surface of the sample by exposing it to the machining laser beam.

The method of the fifth aspect of the invention may include any or all features of the previous aspects of the invention as desired or as appropriate

### DETAILED DESCRIPTION OF THE INVENTION

In order that the invention may be more clearly understood embodiments thereof will now be described, by way of example only, with reference to the accompanying drawings, of which:

FIG. 1 shows an embodiment of an objective lens attachment for a microscope according to the present invention;

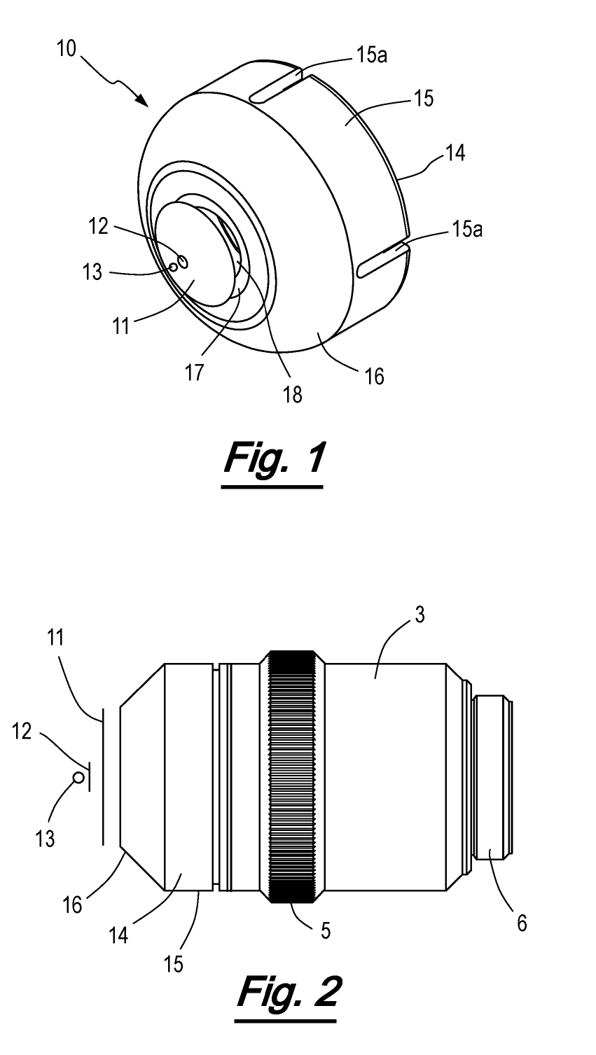

FIG. 2 shows the objective lens attachment of FIG. 1 in position for attachment to the objective lens of a microscope;

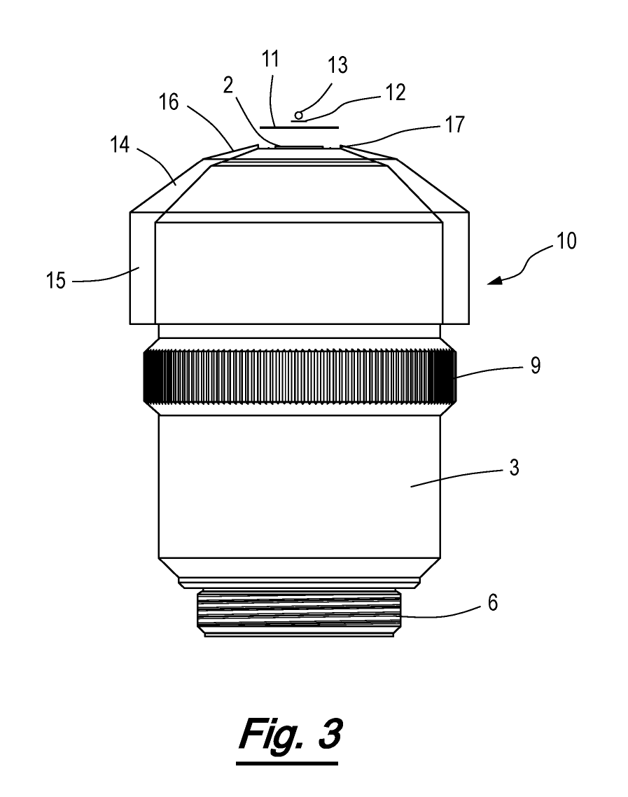

FIG. 3 shows the objective lens attachment of FIG. 1 attached to the objective lens of a microscope;

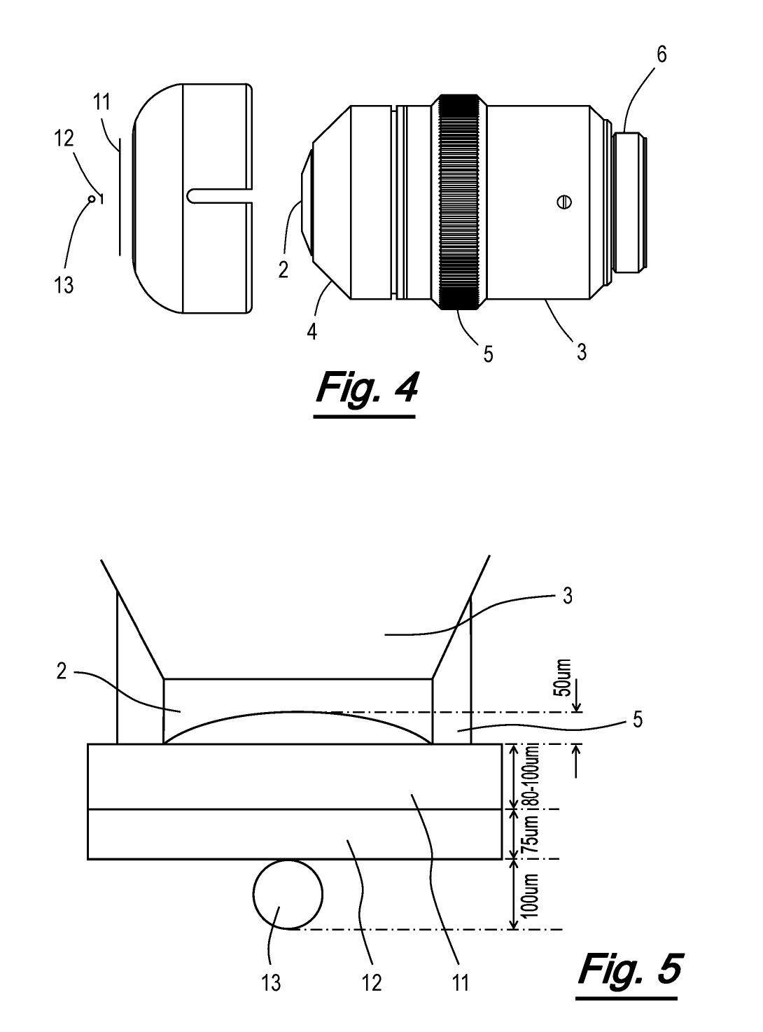

FIG. 4 shows another embodiment of an objective lens attachment for a microscope according to the present invention;

FIG. 5 is a schematic illustration of the positioning of the optical elements of an embodiment of the objective lens attachment of the present invention in relation to the objective lens;

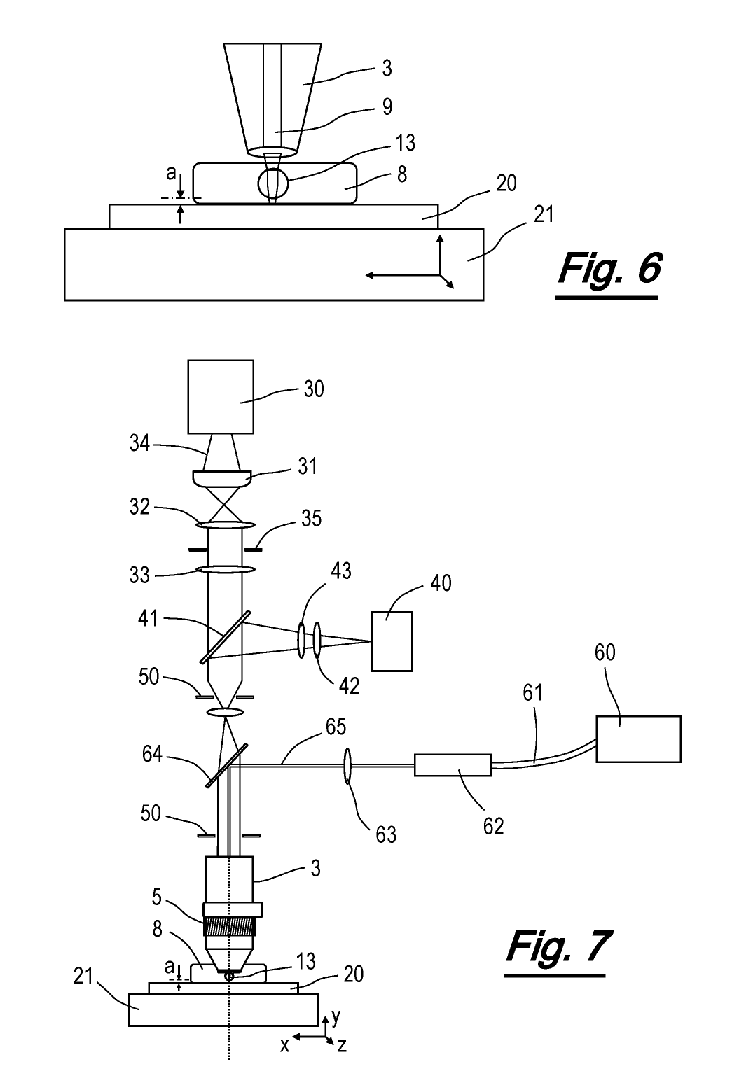

FIG. 6 is a schematic illustration of the positioning of the optical elements of an embodiment of the objective lens attachment of the present invention in relation to the sample;

FIG. 7 is a schematic illustration of the positioning of the optical elements of the objective lens attachment of the present invention in relation to microscope and sample as well as the optional provision of a laser for machining applications;

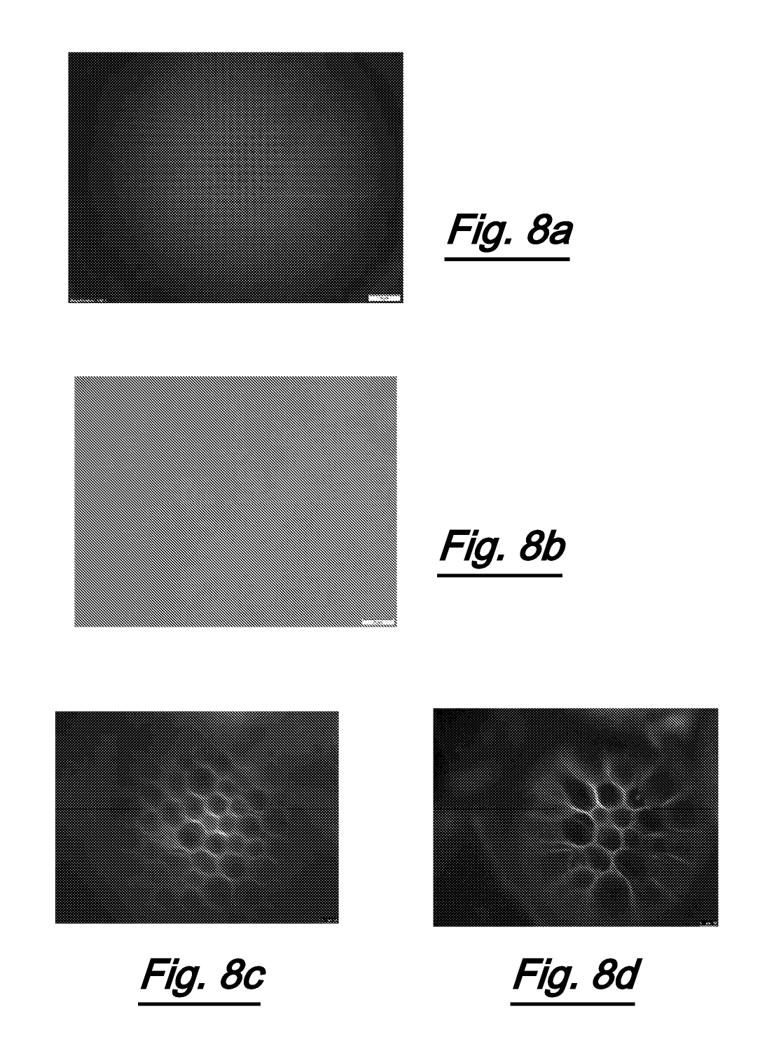

FIG. 8 shows images of: (a) a processed silicon wafer obtained using the objective lens attachment of the present invention and pinhole apertures illustrated in FIG. 7; (b) a processed silicon wafer obtained using the objective lens attachment of the present invention without pinhole apertures illustrated in FIG. 7; (c) a fluorescent stained Convallaria Majalis petal silicon wafer using the objective lens attachment of the present invention without pinhole apertures illustrated in FIG. 7; and (d) a fluorescent stained Convallaria Majalis petal silicon wafer using the objective lens attachment of the present invention and pinhole apertures illustrated in FIG. 7;

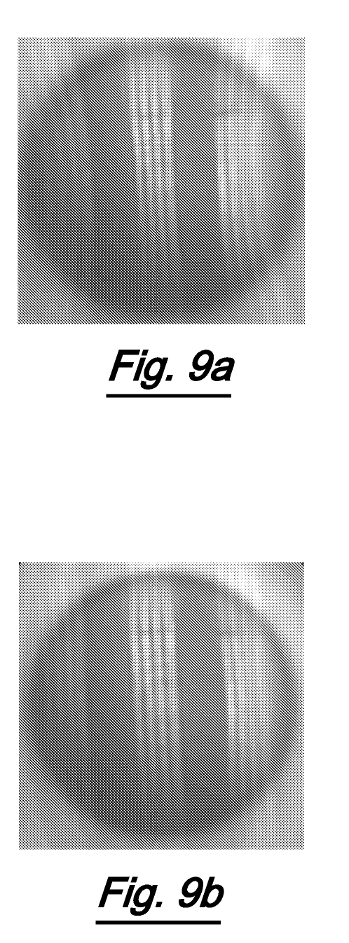

FIG. 9 illustrates (a) pincushion distortion of an image obtained using the objective lens attachment of the present invention, and (b) correction of pincushion distortion;

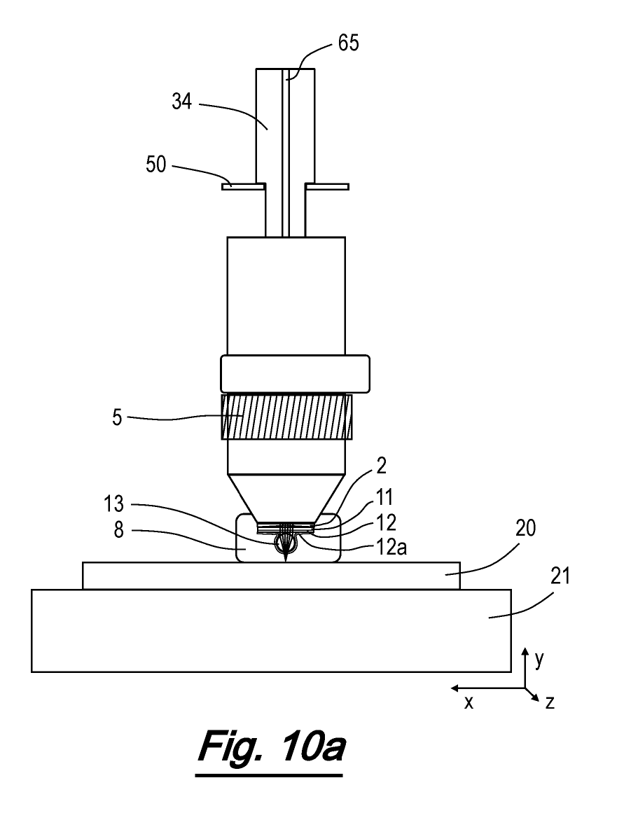

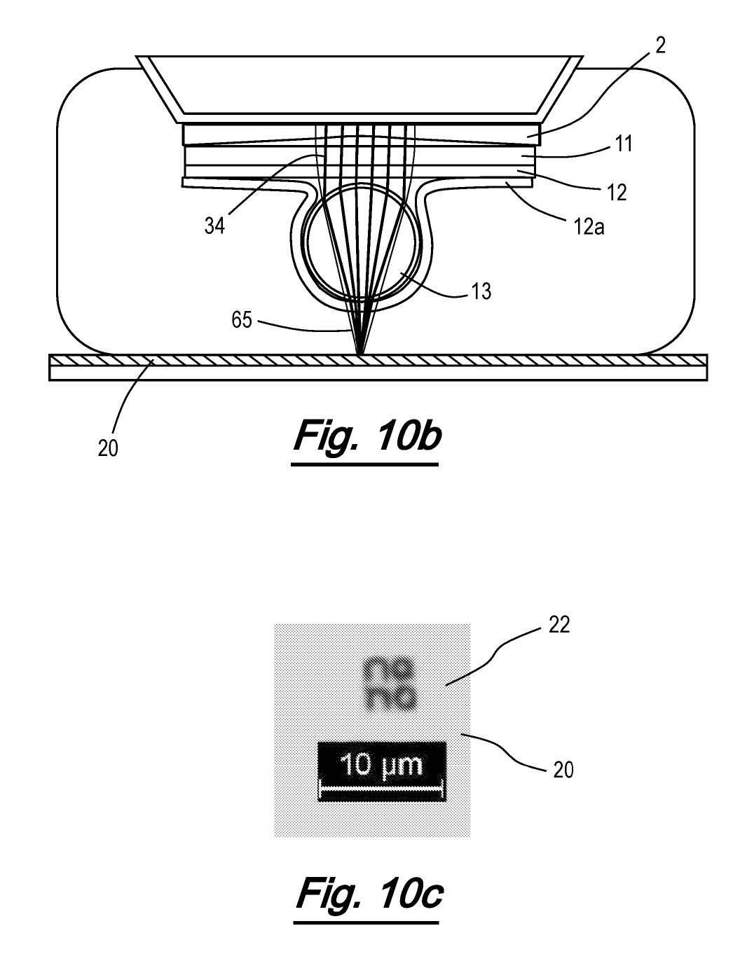

FIG. 10 illustrates schematically (a) use of the objective lens attachment of the present invention for machining; (b) an expanded view of the effect of the microsphere lens on the machining laser beam; and (c) an example of a pattern created on a substrate during machining operation;

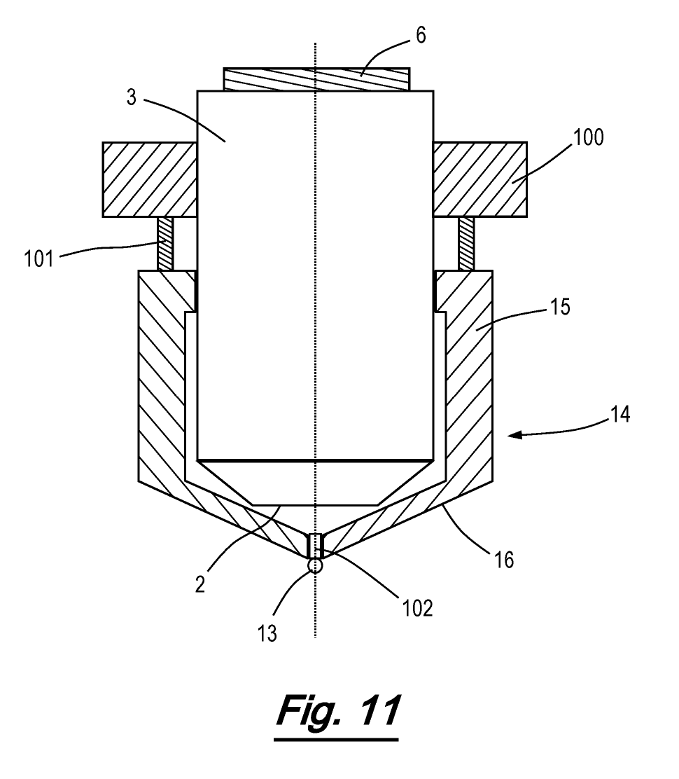

FIG. 11 shows an embodiment of an objective lens attachment for a microscope according to the present invention wherein the separation between the objective lens and the objective lens attachment is adjustable along the optical axis;

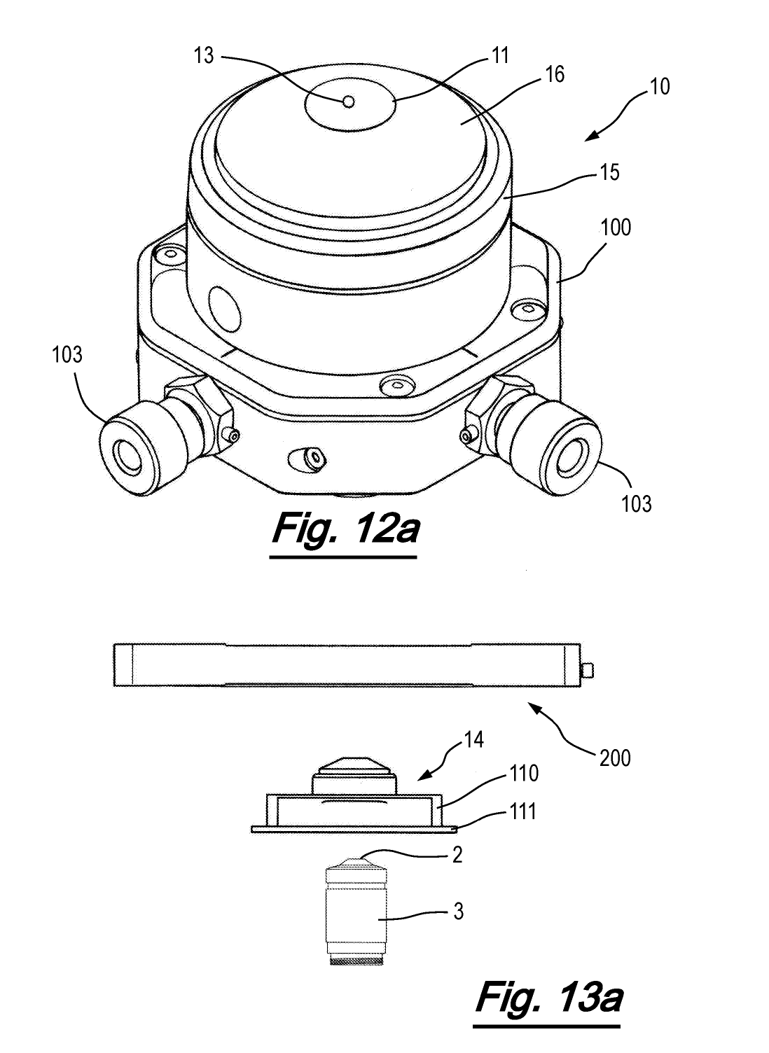

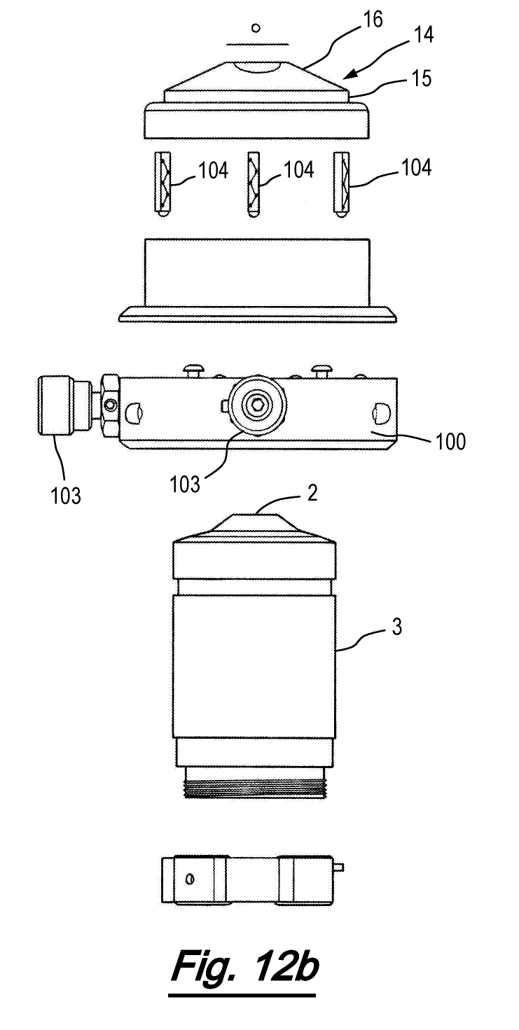

FIG. 12 shows a perspective view (a) and exploded view (b) of an alternative embodiment of an objective lens attachment for a microscope according to the present invention wherein the separation between the objective lens and the objective lens attachment is adjustable along the optical axis; and

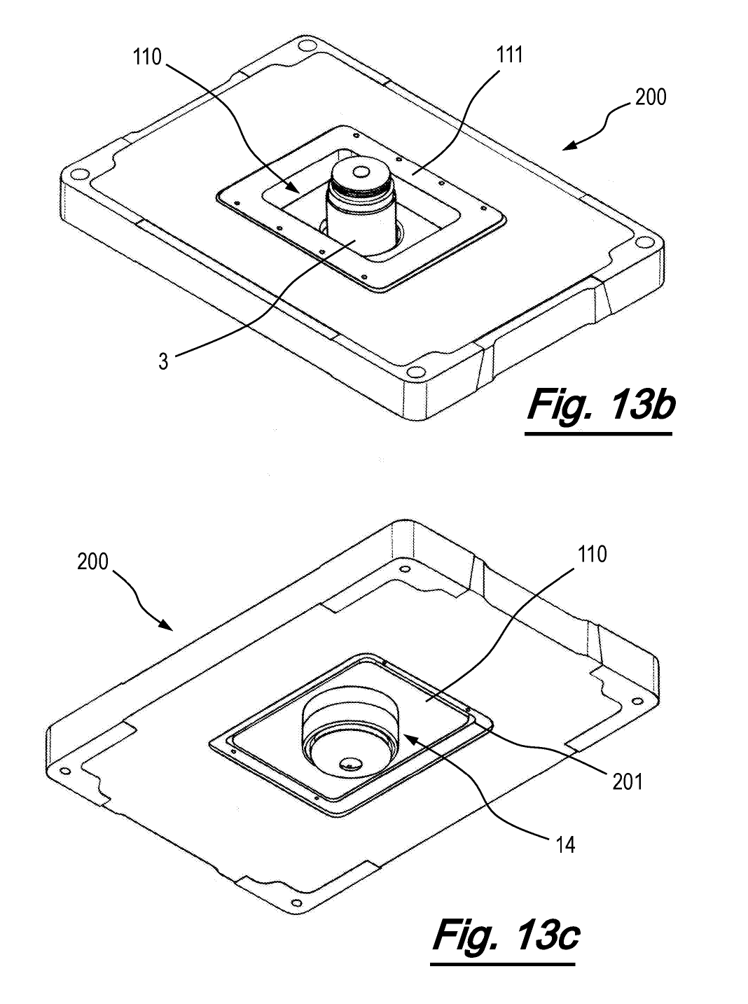

FIG. 13 shows an exploded view (a) and perspective views (b), (c) of an alternative embodiment of an objective lens attachment for a microscope according to the present invention wherein the separation between the objective lens and the objective lens attachment is adjustable along the optical axis.

Turning to FIGS. 1-3, an embodiment of an objective lens attachment 10 according to the present invention for fitting to the housing 3 of an objective lens 2 of a microscope (not shown). In one example, the lens may be an RMS60X-PFC-60X Olympus Plan Fluorite Objective Lens with Correction Collar, 0.9 NA, 0.2 mm Working Distance.

The attachment 10 in use positions a microsphere lens 13 between the objective lens 2 and a sample. In particular, the attachment 10 is adapted to position the microsphere lens at a desired separation from the objective lens 2 to provide optimal super resolution imaging performance.

The objective lens attachment 10 comprises a cap 14 having a substantially tubular body 15 and a top 16. The housing 3 is provided with an end section 4 within which is mounted the objective lens 2. The housing 3 is provided with a rotary adjustment collar 5, enabling adjustment of the objective lens position relative to the microscope body. The housing also comprises a fitting 6 for enabling secure attachment of the housing to the microscope body.

The cap 14 is formed in plastic and is provided with slits 15a. The slits 15a can help ensure close fitting of the cap 14 to the objective lens housing 3. Where the objective lens is designed in use to be immersed in a fluid, the cap 14 may be adapted to retain fluid. In particular, the interior of the tubular body may be provided with a seal to help retain said fluid and/or a valve facilitating the introduction or removal of said fluid.

In some embodiments, the cap 14 may be formed from moulded plastic. It is also possible for the tap to be produced by 3D printing using a suitable resin. In such embodiments, the cap may be cleaned in isopropyl alcohol and polished if required. The interior of the body 15 may be adapted to aid fixing of the cap 14 to the objective lens housing 3. This may include the provision of gripping formations and/or a screw thread. Alternatively, this may be achieved by applying adhesive to the interior of the body 15.

The top 16 is provided with a contact surface 17 surrounding an aperture 18. The aperture 18 is aligned with the objective lens when the cap 14 is fitted to the objective lens housing 3.

A support sheet 11 is affixed to the cap 14. The support sheet 11 is formed from glass but may be formed from any other suitable optically clear material. An example of a suitable material for the support sheet 11 are the glass slides manufactured by Agar Scientific under product number is AGL46R10-0.

The fixing of the support sheet 11 to the cap 14 is achieved by the use of adhesive provided on the contact surface 17. In one example, the adhesive may be NOA 81 UV curable adhesive supplied by Norland Products. The adhesive may be cured using a 4W (optical power), 365 nm wavelength UV lamp for 30 minutes.

Upon the support sheet 11 is provided an adhesive layer 12. The adhesive layer may be formed from a sheet of optically clear adhesive tape. A suitable adhesive tape is the optically clear double-sided adhesive tape supplied under catalogue number OCA8146-3 by 3M. By using tape of a specified thickness, an adhesive layer of a desired thickness can readily be achieved. In alternative embodiments, the adhesive layer 12 may be formed by applying optical adhesive to the support sheet 11 so as to form a layer of the desired thickness. This can be achieved by applying a drop of optical adhesive and spinning the support sheet until the adhesive layer is of a desired thickness. The benefit of using optical adhesive rather than optical tape is that it is easier to ensure matching of the refractive index of the adhesive layer 12 and the support sheet 11 and/or microsphere 13 than when using tape which comprises both adhesive and a substrate.

The adhesive layer 12 is provided over at least the centre of the support sheet 11. In this way, the adhesive layer 12 is aligned with the centre of the objective lens when the cap is attached to the objective lens housing.

Affixed to the adhesive layer 12 is a microsphere lens 13 formed from Barium Titanate (BaTiO₃) and having a refractive index of around 1.93. The microsphere lens is aligned with the centre of the objective lens 2.

In the present embodiment, the microsphere lens 13 has a diameter of around 100 μm. In alternative embodiments, it is however possible to use BaTiO₃ microsphere lenses with diameters in the range 30 μm-1000 μm.

In order to ensure accurate alignment of the microsphere lens 13 with the centre of the objective lens 2, the microsphere lens 13 is affixed to the adhesive layer after the cap is fitted to the housing 3. Instead, the microsphere lens 13 is placed on a clean microscope slide. The controls on the microscope are then operated to centre the microsphere lens 13 within the field of view. This initial stage may be carried out using a second, lower magnification objective lens (e.g. ×10 or ×20) to which the cap is not attached. When the microsphere lens 13 is appropriately positioned, the objective lens 2 fitted with the attachment 10 is advanced towards the slide until the adhesive layer 12 contacts the microsphere lens 13. As a result of this contact, the microsphere lens 13 becomes affixed to the adhesive layer 12. When the objective lens is subsequently moved away from the slide, the microsphere lens 13 remains affixed to the adhesive layer 12.

In order to further secure the microsphere lens 13 in position, a surface coating layer 12a (see FIG. 10b) may be applied over the microsphere lens, the adhesive layer 12 and the support sheet 11. The surface coating layer 12a may comprise an optical adhesive. In one example, the surface coating layer may comprise a 40% NOA 81 UV optical adhesive solution (2 parts adhesive, 3 parts acetone). One drop of the above solution is poured onto the support sheet. The attachment 10 (or the objective lens housing 3 and attachment 10) is then spun until the surface coating layer 12a reaches a desired uniform thickness. In one example the surface coating layer is around 10 μm thick. Subsequently, the surface coating layer 12a may be cured under suitable UV illumination for 1 hour or so.

Turning now to FIG. 4, an alternative embodiment of the attachment 10 is shown. In this embodiment, the cap 14 is formed from metal and is designed to replace the existing front section 5 of the objective lens housing 3. In other respects, the attachment 10 is substantially the same as the attachment 10 of FIGS. 1-3.

Turing now to FIG. 5, a schematic cross-section of the attachment of the invention is shown. As can be seen, the support sheet 11 substantially abuts the objective lens 2. The thickness of the support sheet 11 and the thickness of the adhesive layer 12 are chosen such that the combined thickness is equal to a desired separation of the microsphere lens 13 and the objective lens 2. In this manner, the microsphere lens 13 can be simply, robustly and accurately positioned at a desired separation from the objective lens 2. In the example embodiments described herein, the adhesive layer 12 is formed of optical tape of known thickness (75 μm) and thus the thickness of the support sheet 11 is selected such that the optimal separation is achieved. In the example described, the glass slide may have a thickness in the region of 80-100 μm. If sheets of the appropriate thickness are not available commercially, it is possible to machine a sheet to the desired thickness.

The specific separation of the microsphere lens 13 and objective lens 2 is selected based upon the power of the objective lens 2 and the properties of the microsphere lens 13. Such a distance is normally between 50-400 μm depending on microsphere size, material, objective lens power, numerical aperture and surrounding media. In some instances, such as the attachment 10 of FIG. 4, there is provision for adjustment of the position of the attachment so as to increase separation of the support sheet 11 from the objective lens. This can compensate for differences in support sheet 11 thickness or microsphere lens properties 13, as well as correcting minor errors in focussing.

Turning now to imaging operation, schematic illustrations of the use of the microsphere lens 13 in imaging operation are shown in FIGS. 6 and 7. For clarity, these illustrations omit the support sheet 11 and adhesive layer 12. Turning first to FIG. 6, a sample 20 for imaging is provided upon an XYZ scanning stage 21. The scanning stage 21 is operable to be controllably moved with respect to the objective lens 2. In particular, the scanning stage 21 may be moved in the Z direction (aligned with the optical axis of the microscope), towards or away from the microsphere lens 13. In this way, the separation a between the microsphere lens 13 and the sample 20 can be varied for optimum imaging performance. In some embodiments, the separation may be preselected according to the properties of based upon the power of the objective lens 2 and the properties of the microsphere lens 13. Typically, in the present example, the separation might be in the region of 305 μm-325 μm. In other embodiments, the separation may be manually adjusted for optimum results.

The scanning stage 1 may also be moved in the XY plane, perpendicular to the optical axis of the microscope. This can allow a wider imaging of the sample t by scanning the sample 20 past the microsphere lens 13.

The skilled man will of course appreciate that adjustment of the separation between the microsphere lens 13 and the sample 20 or scanning of the sample relative to the microsphere lens may equally be achieved by movement of the microscope or objective lens relative to a fixed sample mount.

In FIGS. 6 and 7, the sample 20 is illuminated in reflective mode by light 9 directed through the objective lens 2. The skilled man will however appreciate that it is of course possible to utilise the present invention under transmissive illumination given a suitable sample mount or scanning stage 21.

In both FIGS. 6 & 7, a fluid 8, typically distilled or deionised water is provided between the microsphere lens 13 and the sample 20. The provision of this fluid can improve imaging performance due to the tuning of refractive index, light intensity on the target, and focal plane distance. The fluid may be applied directly to the sample surface. In some embodiments, the top 16 of cap 14 may be provided with additional sealing projections to retain the fluid in position relative to the sample 20.

Turning more specifically to FIG. 7, the illumination 9 is generated by a light source 30. Light 34 generated by the light source 30 is focussed and collimated by lenses 31-33 and aperture 35. Imaging is achieved by use of an imaging device 40, typically comprising a CCD array or the like. A beam splitter 41, for example a near IR hot mirror, is provided to enable illumination from the light source 30 to be directed to the sample and for reflected light from the sample to pass on to the imaging device 40. If necessary, the imaging device may be provided with an additional lens 42 to improve focus or field of view and a low pass filter 43.

To further improve resolution of the image, an additional aperture (slit modulator) 50 can be provided in the path of the illuminating light lens in order to generate a dark field and illuminate the object. The aperture rejects the out of focus light that would otherwise reach the detector resulting in blur. The smaller the size of the aperture 50, the greater the increase in resolution, albeit at the cost of a reduced field of view. The optimal slit width is in the range of 0.2 mm-2 mm. The effect of the additional aperture 50 is illustrated in the images of FIG. 8 whereby: FIG. 8a comprises a captured image of a processed silicon wafer utilising an additional aperture 50; FIG. 8b illustrates a captured image of the same wafer without the additional aperture 50; FIG. 8d comprises a captured image of fluorescent stained Convallaria Majalis petal silicon wafer utilising an additional aperture 50; and FIG. 8c illustrates a captured image of the same wafer without the additional aperture 50. Use of a microsphere lens 13 between the objective lens 2 and the sample introduces some radial distortion into images captured using the present arrangement. The nature of the distortion (known as pincushion distortion) is that points are displaced in the radial direction away from the optical axis. This results in straight lines being imaged as curves. This distortion is illustrated in the captured image of FIG. 9a.

The distortion can be corrected by use of pincushion distortion image processing algorithms as is known in the art. A corrected version of the image of FIG. 9a generated by an image processing algorithm is shown at FIG. 9b.

Additionally or alternatively, the microsphere lens may be formed from a truncated microsphere rather than a full microsphere. In such cases, the microsphere is truncated at a plane perpendicular to the optical axis and substantially parallel to the plane of the sample. Providing a planar face to light from the sample reduces distortion in the captured image but reduces the resolving power.

Also shown in FIG. 7 are additional components that enable the use of the apparatus for machining. These components and their operation are described in relation to FIG. 7 and FIGS. 10a-10c. Specifically, these components include a laser 60, which may be a pigtailed diode laser (up to 1W optical power, at say 925 nm), operable to generate a laser beam 65 for machining the surface of sample 20. For machining (nanolithography), the laser beam 65 is transmitted through an optical fibre 61 and IR laser fibre coupler 62. Subsequently the beam 65 is collimated by lens 63 and then directed into the objective lens 2 by a dichroic mirror 64 (positioned at 45 degrees). This dichroic mirror 64 couples the laser 60 with the imaging system. The laser beam passes through the objective lens 2, through the support sheet 11 and adhesive layer 12 and reaches the microsphere lens 13 which focuses the beam 65. The beam 65 is focused by the microsphere 13 at a distance “a” (depending of the diameter of the sphere). The distance is adjusted using the Z positioning stage 21. The sample is moved using an XY stage 21 according a pattern drew in a computer software. The microsphere 13 may be optionally immersed in fluid (depending of the refractive index of the microsphere 13). In one example, the minimum pointwise feature that can be patterned using this apparatus is 30 nm (e.g.: using 5 um silica microsphere and tungsten substrate). The depth of the pattern 22 can be adjusted by adjusting the power level of laser 60. The pattern 22 depth and resolution will of course depended also upon properties of the sample 20. While polymers cannot offer a good resolution, metals can offer a resolution down to 30 nm. An example of a pattern 22 formed on a GeStTe substrate using a 5 um diameter microsphere lens 13 formed from silica (SiO₂) is illustrated at FIG. 10c.

If desired, the sample 20 can be imaged in the same time as machining. In order to do so, light source 30 is used to inject white light 34 into the objective lens 2. A virtual image is formed which is transmitted onto the camera 40. The image resolution can be adjusted using the slits 50 in order to reject the unwanted reflected light from the sample 20. Unwanted reflection of the infrared laser beam 65 are rejected before reaching the camera 40 by low pass filter 43.

For imaging without machining, the laser 60 is turned off. Light 34 is injected into the system using light source 30 to the microsphere lens 13. A virtual image is formed which is transmitted onto the camera 40. The image resolution can be adjusted using the slits 50 in order to reject the unwanted reflected light from the sample 20. Unwanted reflection of the infrared laser beam 65 are rejected before reaching the camera 40 by low pass filter 43.

Turing now to FIG. 11, a further embodiment of the invention is shown. In this embodiment, the objective lens attachment 10 comprises a cap 14 having a substantially tubular body 15 and a top 16 as before. In addition to the cap 14, the attachment 10 comprises a base 100, in the form of a collar adapted to be securely attached to the housing 3 of objective lens 2. The base 100 contains a stepper motor and is connected to the cap 14 by threaded elements 101. Operation of the motor can thus accurately control the relative displacement of the cap 14 and base 100. Accordingly, this can also control the relative displacement between the objective lens 2 and the microsphere lens 13.

To compensate for this variation in displacement a graded index optical element 102 having a refractive index that decreases with increasing radial distance from the optical axis of the element can be provided between the microsphere 13 and the objective lens 2. In some embodiments, the graded index optical element 102 may be affixed directly to the support sheet 11. In other embodiments, the support sheet 11 may effectively comprise an end face of the graded index optical element.

The embodiment of FIG. 11 can be utilised for imaging when positioned directly on an objective lens housing 3 or as an endoscopic probe optically connected to the objective lens 2 by the graded index optical element 102.

Turning now to FIG. 12, an alternative embodiment of the invention enabling control of the relative displacement between the objective lens 2 and the microsphere lens 13 is shown. As in FIG. 11, the objective lens attachment 10 comprises a cap 14 having a substantially tubular body 15 and a top 16 as before. In addition to the cap 14, the attachment 10 comprises a base 100, in the form of a collar adapted to be securely attached to the housing 3 of objective lens 2 by way of fixing screws 103. In this embodiment, the base 100 is connected to the cap 14 by piezoelectric actuators 104 rather than screw threads 101. Applying a suitable input to the piezoelectric actuators enables the relative displacement between the objective lens 2 and the microsphere lens 13 to be controllably adjusted.

Turning now to FIG. 13 a further embodiment of the invention is illustrated. In this embodiment, the objective lens attachment 10 is fixed within a socket 201 provided in a scanning stage 200. The objective lens 10 attachment is provided with an extended pedestal 110 adapted to fit the socket 201. Typically this might be achieved by use of pins, screws or the like projecting through a rim 111 of the pedestal 110. The scanning stage 200 can be operated to control the location of the cap 14 relative to the objective lens 2 and provide ready adjustment of the relative displacement of the cap 14 from the objective lens 2 along the optical axis and/or the relative displacement of the cap 14 from the objective lens 2 in a plane perpendicular to the optical axis.

The above embodiments are described by way of example only. Many variations are possible without departing from the scope of the invention as defined in the appended claims.

1. An objective lens attachment for a microscope, the attachment comprising:
a cap locatable relative to an outer housing of an objective lens;
a support sheet affixed to the cap;
an adhesive layer provided on the support sheet; and
a microsphere lens affixed to the support sheet by the adhesive layer, the microsphere lens aligned to an optical axis of the objective lens.

2. An objective lens attachment as claimed in claim 1, wherein the microsphere lens comprises a microsphere or a truncated microsphere.

3. An objective lens attachment as claimed in claim 1, wherein the cap comprises a substantially tubular body and a top.

4. An objective lens attachment as claimed in claim 1, wherein the cap is releasably attachable to the outer housing of the objective lens.

5. An objective lens attachment as claimed in claim 1, wherein a relative displacement of the cap from the objective lens along the optical axis is adjustable.

6. An objective lens attachment as claimed in claim 5, wherein the cap is connected via adjustment means to a base, the base being adapted to attach to the outer housing of the objective lens in a fixed location.

7. An objective lens attachment as claimed in claim 5, wherein the cap is fitted within a dedicated socket provided in a scanning stage, the scanning stage being operable to control a location of the cap relative to the objective lens.

8. An objective lens attachment as claimed in claim 5, wherein a graded index optical element is provided between the support sheet and the objective lens.

9. An objective lens attachment as claimed in claim 1, wherein the cap is provided with a seal so as to retain fluid between the support sheet and the objective lens.

10. An objective lens attachment as claimed in claim 1, wherein the adhesive layer comprises an optical adhesive applied to the support sheet and spun to a desired thickness.

11. An objective lens attachment as claimed in claim 1, wherein the adhesive layer comprises an optically clear adhesive tape of a known thickness applied to the support sheet.

12. An objective lens attachment as claimed in claim 1, wherein the attachment comprises a surface coating layer applied over the adhesive layer and the microsphere lens.

13. An objective lens attachment as claimed in claim 1, wherein the cap is provided with sealing projections for retaining a fluid between the microsphere lens and a sample.

14. A method of constructing an objective lens attachment for a microscope, comprising the steps of:
affixing a support sheet to a cap attachable to an outer housing of an objective lens;
providing an adhesive layer on the support sheet; and
affixing a microsphere lens to the adhesive layer.

15. A method as claimed in claim 14 wherein providing the adhesive layer on the support sheet includes applying a desired quantity of an adhesive solution to the support sheet and spinning the support sheet until a uniform layer of a desired thickness is formed.

16. A method as claimed in claim 14, wherein providing the adhesive layer on the support sheet includes applying a layer of adhesive tape of a desired thickness to the support sheet.

17. A method as claimed in 14, wherein affixing the microsphere lens to the adhesive layer includes placing the microsphere lens on a clean microscope slide; and approaching the microsphere lens with the adhesive layer on the support sheet; and wherein affixing the microsphere lens includes centring the microscope slide relative to the objective lens of the microscope using a low magnification objective lens.

18. A method as claimed in any claim 14, wherein the method comprises applying a surface coating layer over the adhesive layer and the microsphere lens by applying a desired quantity of an adhesive solution to the support sheet and microsphere lens and spinning the support sheet until a uniform layer of a desired thickness is formed.

19. A method as claimed in claim 14, wherein the method includes the additional step of affixing a graded index optical element to the support sheet and/or the cap.

20. A super resolution microscopy apparatus comprising:
a microscope;
a cap attached to an outer housing of an objective lens of the microscope;
a support sheet affixed to the cap;
an adhesive layer provided on the support sheet; and
a microsphere lens affixed to the support sheet by the adhesive layer, the microsphere lens aligned to an optical axis of the objective lens.

21. (canceled)

22. (canceled)

23. (canceled)

24. (canceled)

25. A method of super resolution microscopy utilising a a microscope including an objective lens attachment according to claim 1, the method comprising:
providing a sample;
positioning the objective lens attachment relative to the sample; and
capturing one or more images of the sample.

26. (canceled)

27. (canceled)

28. (canceled)

29. A method of machining utilising a microscope apparatus according to claim 20, the method comprising:
providing a sample;
positioning the objective lens relative to the sample;
providing a machining laser beam source, aligned such that a machining laser beam passes through the objective lens and the microsphere lens; and
machining a target surface of the sample by exposing the target surface to the machining laser beam.
